(19) United States
(12) Patent Application Publication
(10) Pub. No.: US 2026/0045751 A1
(43) Pub. Date: Feb. 12, 2026

(54) CONNECTOR, CONNECTOR SYSTEM, AND METHOD FOR ASSEMBLING CONNECTOR

(71) Applicant: I-PEX Inc., Kyoto-shi (JP)

(72) Inventor: Tomohiko TANIGAWA, Fukuoka (JP)

(21) Appl. No.: 19/361,010

(22) Filed: Oct. 17, 2025

Related U.S. Application Data
(63) Continuation of application No. PCT/JP2024/015335, filed on Apr. 17, 2024.

(30) Foreign Application Priority Data
Apr. 21, 2023 (JP) 2023-070004

(51) Int. Cl. H01R 43/20; H01R 13/504; H01R 13/518; H01R 13/6591

(52) U.S. Cl. CPC H01R 43/20; H01R 13/5045; H01R 13/518; H01R 13/65915

(57) ABSTRACT

A connector is configured to mate with a counterpart connector along a mating orientation. The connector includes: a plurality of pairs of conductive first contacts arranged along an arrangement orientation perpendicular to the mating orientation and configured to be respectively connected to a plurality of pairs of first insulated wires; a plurality of pairs of conductive second contacts arranged parallel to the plurality of pairs of first contacts in an orthogonal orientation perpendicular to the mating orientation and the arrangement orientation, and configured to be respectively connected to a plurality of pairs of second insulated wires; a plurality of conductive first shells surrounding the plurality of pairs of first contacts pair by pair around the mating orientation; and a plurality of conductive second shells surrounding the plurality of pairs of second contacts pair by pair around the mating orientation.

### CROSS-REFERENCE TO RELATED APPLICATIONS

This application is a continuation application of PCT Application No. PCT/JP2024/015335, filed on Apr. 17, 2024, which claims the benefit of priority from Japanese Patent Application No. 2023-070004, filed on Apr. 21, 2023. The entire contents of the above listed PCT and priority applications are incorporated herein by reference.

### BACKGROUND

### Field

The present disclosure relates to a connector, a connector system, and a method of assembling a connector.

### Description of the Related Art

Japanese Unexamined Patent Publication No. 2019-87462 discloses a connector including a plurality of first cable-side contacts respectively connected to ends of a plurality of upper first cables, a plurality of second cable-side contacts respectively connected to ends of a plurality of lower second cables, a cable-side housing that holds the plurality of first cable-side contacts and the plurality of second cable-side contacts in a state of being offset in a front-rear direction, and a shield member that covers the cable-side housing.

### SUMMARY

Disclosed herein is a connector configured to be connected to a plurality of pairs of first insulated wires and a plurality of pairs of second insulated wires and to mate with a counterpart connector along a mating orientation. The connector may include: a plurality of pairs of conductive first contacts arranged along an arrangement orientation perpendicular to the mating orientation and configured to be respectively connected to the plurality of pairs of first insulated wires; a plurality of pairs of conductive second contacts arranged parallel to the plurality of pairs of first contacts in an orthogonal orientation perpendicular to the mating orientation and the arrangement orientation, and configured to be respectively connected to the plurality of pairs of second insulated wires; a plurality of conductive first shells surrounding the plurality of pairs of first contacts pair by pair around the mating orientation; and a plurality of conductive second shells surrounding the plurality of pairs of second contacts pair by pair around the mating orientation.

Additionally, a method of assembling the connector is disclosed herein. The method may include: connecting a plurality of pairs of first insulated wires respectively to a plurality of pairs of conductive first contacts of a first unit, the first unit comprising the plurality of pairs of conductive first contacts arranged along an arrangement orientation perpendicular to the mating orientation and an insulative first housing that holds the plurality of pairs of first contacts; connecting a plurality of pairs of second insulated wires respectively to a plurality of pairs of conductive second contacts of a second unit, the second unit comprising the plurality of pairs of conductive second contacts arranged along the arrangement orientation and an insulative second housing that holds the plurality of pairs of second contacts; attaching a plurality of conductive first shells to the first unit so as to surround the plurality of pairs of first contacts to which the plurality of pairs of first insulated wires are respectively connected, wherein each of the plurality of first shells surrounds one pair of first contacts per first shell; attaching a plurality of conductive second shells to the second unit so as to surround the plurality of pairs of second contacts to which the plurality of pairs of second insulated wires are respectively connected, wherein each of the plurality of second shells surrounds one pair of second contacts; and integrating the second housing and the first housing such that the plurality of pairs of first contacts and the plurality of pairs of second contacts are arranged parallel to each other in an orthogonal orientation perpendicular to the mating orientation and the arrangement orientation

### BRIEF DESCRIPTION OF THE DRAWINGS

FIG. 1 is an example perspective view illustrating a connector system before mating.

FIG. 2 is an example perspective view illustrating a state in which a plug connector is mated with a receptacle connector.

FIG. 3 is a cross-sectional view taken along line III-III in FIG. 1.

FIG. 4 is a cross-sectional view taken along line IV-IV in FIG. 1.

FIG. 5 is a cross-sectional view taken along line V-V in FIG. 2.

FIG. 6 is a cross-sectional view taken along line VI-VI in FIG. 2.

FIG. 7 is an example exploded perspective view illustrating a configuration of the receptacle connector.

FIG. 8 is an example perspective view illustrating a configuration of a housing.

FIG. 9 is an example perspective view illustrating a configuration of the housing.

FIG. 10 is an example exploded perspective view illustrating a configuration of the plug connector.

FIG. 11 is an example exploded perspective view illustrating a configuration of a first connector.

FIG. 12 is an example perspective view illustrating a configuration of a first base plate.

FIG. 13 is an example perspective view illustrating a configuration of a first shell.

FIG. 14 is an example perspective view illustrating a configuration of a first housing.

FIG. 15 is an example perspective view illustrating a configuration of the first housing.

FIG. 16 is an example exploded perspective view illustrating a configuration of a second connector.

FIG. 17 is an example perspective view illustrating a configuration of a second housing.

FIG. 18 is an example perspective view illustrating a configuration of the second housing.

### DETAILED DESCRIPTION

In the following description, with reference to the drawings, the same reference numbers are assigned to the same components or to similar components having the same function, and overlapping description is omitted.

A connector system 1 is used for connecting a circuit board 10 and a plurality of pairs of insulated wires 30 in applications that require transmission of high-frequency signals with low degradation and a low profile. Each of the plurality of pairs of insulated wires 30 transmits one signal (a differential signal) per pair. An example of such an application is an information processing system in which signal transmission on the circuit board 10 is performed by the plurality of pairs of insulated wires 30 instead of printed wiring on the circuit board 10. By using shielded cables for each of the plurality of pairs of insulated wires 30, for example, signals can be transmitted with higher signal transmission characteristics than with printed wiring. Signal transmission characteristics mean the smallness of signal degradation in signal transmission, and high signal transmission characteristics mean that signal degradation in signal transmission is small. Examples of signal degradation include noise mixing due to crosstalk and signal attenuation.

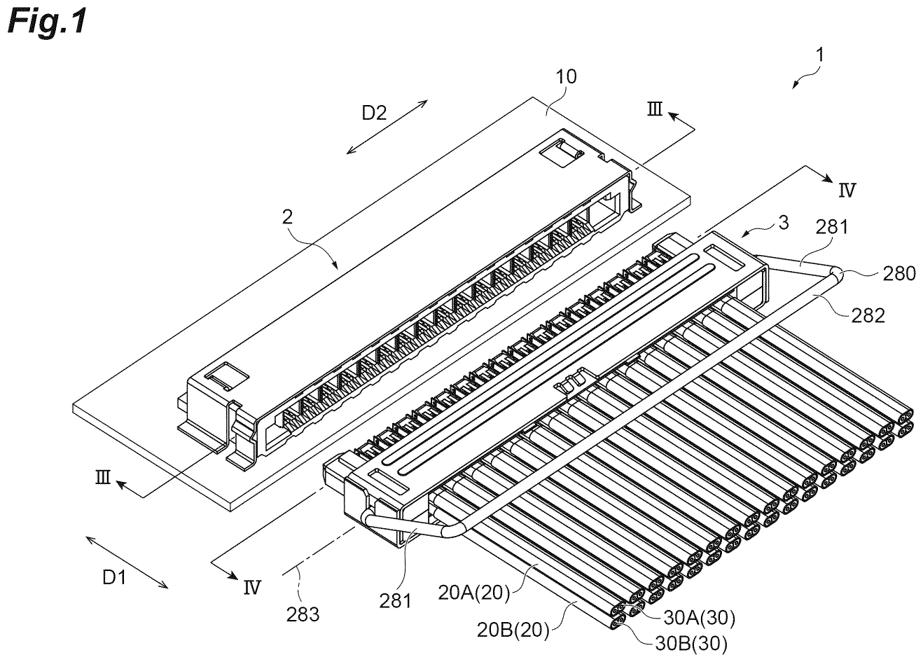

As illustrated in FIG. 1, the connector system 1 includes a receptacle connector 2 and a plug connector 3. The receptacle connector 2 is provided on the circuit board 10 and mates with the plug connector 3 along a mating orientation D1 parallel to the circuit board 10. The mating orientation D1 may be substantially parallel to the circuit board 10, and may be slightly tilted with respect to the circuit board 10 due to a mounting error of the receptacle connector 2 or the like.

The plug connector 3 is connected to the plurality of pairs of insulated wires 30 and mates with the receptacle connector 2 along the mating orientation D1. For example, the plug connector 3 is connected to a plurality of shielded cables 20, each having a pair of insulated wires 30. The plurality of shielded cables 20 include a plurality of first shielded cables 20A arranged in a first row and a plurality of second shielded cables 20B arranged in a second row that is parallel to the first row. The plurality of pairs of insulated wires 30 include a plurality of pairs of first insulated wires 30A included in the plurality of first shielded cables 20A and arranged in the first row, and a plurality of pairs of second insulated wires 30B included in the plurality of second shielded cables 20B and arranged in the second row.

The distinction between the plurality of first shielded cables 20A and the plurality of second shielded cables 20B (the distinction between the plurality of pairs of first insulated wires 30A and the plurality of pairs of second insulated wires 30B) is a distinction based on arrangement, and the respective configurations of the plurality of first shielded cables 20A and the respective configurations of the plurality of second shielded cables 20B are the same.

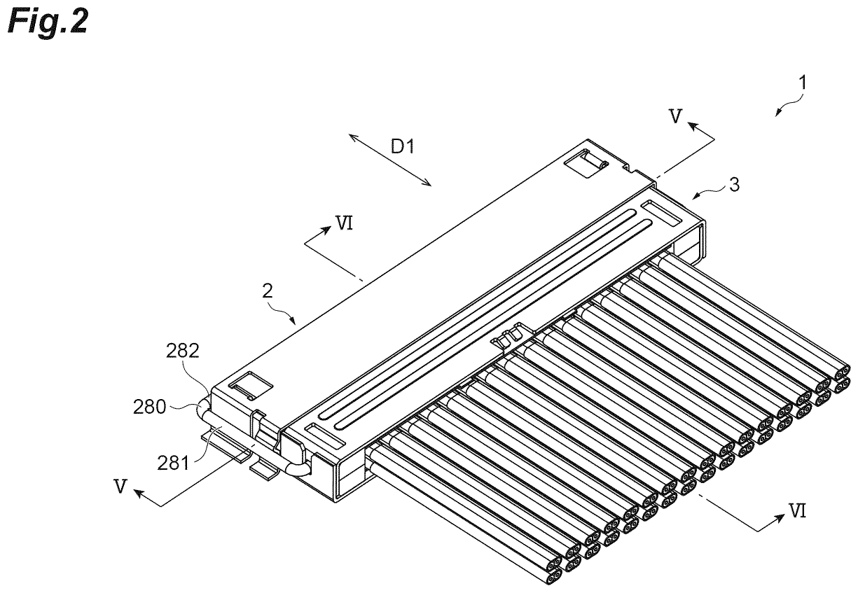

Mating along the mating orientation D1 means mating by movement along the mating orientation D1. The plug connector 3 is a “counterpart connector” to the receptacle connector 2, and the receptacle connector 2 is a “counterpart connector” to the plug connector 3. FIG. 2 illustrates a state in which the plug connector 3 is mated with the receptacle connector 2 along the mating orientation D1.

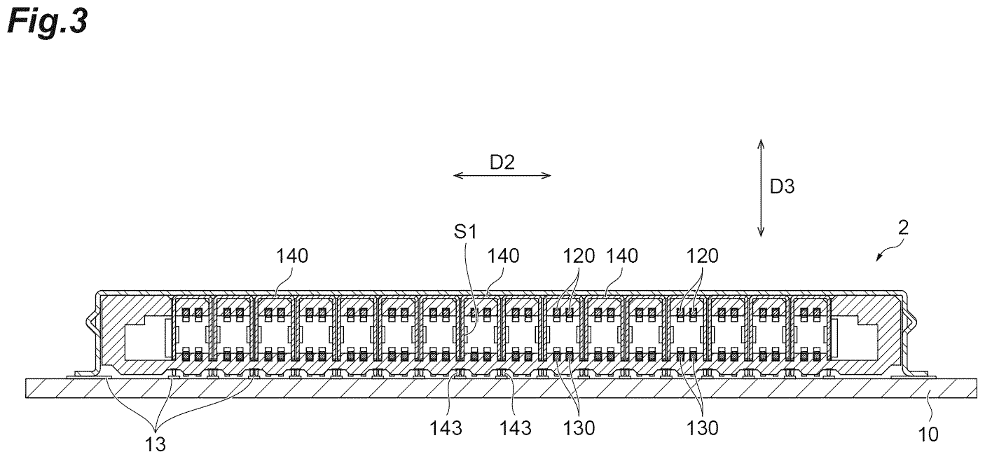

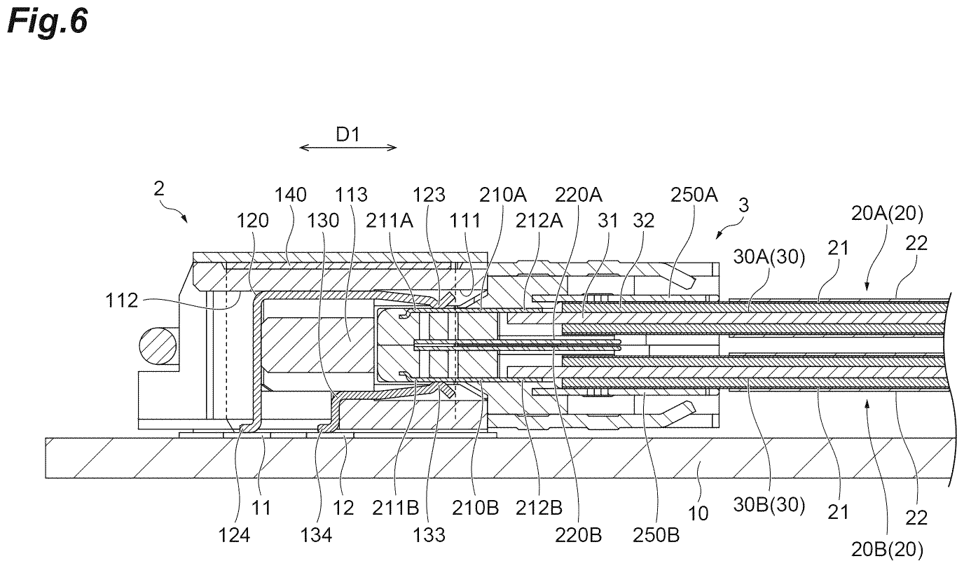

FIG. 3 is a cross-sectional view taken along line III-III in FIG. 1. As illustrated in FIG. 3, the receptacle connector 2 includes a plurality of pairs of conductive first contacts 120, a plurality of pairs of conductive second contacts 130, and a plurality of conductive shells 140. The plurality of pairs of first contacts 120 are arranged along an arrangement orientation D2 that is parallel to the circuit board 10 and perpendicular to the mating orientation D1, and are respectively connected to a plurality of pairs of first signal lines 11 (see FIG. 6) of the circuit board 10. The plurality of pairs of second contacts 130 are arranged along the arrangement orientation D2 between the plurality of pairs of first contacts 120 and the circuit board 10, and are respectively connected to a plurality of pairs of second signal lines 12 (see FIG. 6) of the circuit board 10.

The arrangement orientation D2 may be substantially parallel to the circuit board 10, and may be slightly inclined with respect to the circuit board 10 due to a mounting error of the receptacle connector 2 or the like. The arrangement orientation D2 may be substantially perpendicular to the mating orientation D1, and may be slightly inclined with respect to a direction perpendicular to the mating orientation D1 due to a manufacturing error of the receptacle connector 2 or the like.

The plurality of shells 140 are arranged along the arrangement orientation D2 and surround the plurality of pairs of first contacts 120 and the plurality of pairs of second contacts 130, one pair of first contacts 120 and one pair of second contacts 130 per shell (wherein each of the plurality of shells 140 surrounds one pair of first contacts 120 and one pair of second contacts 130), around the mating orientation D1. For example, each of the plurality of shells 140 surrounds a pair of first contacts 120 and a pair of second contacts 130 arranged along an orthogonal orientation D3 perpendicular to the mating orientation D1 and the arrangement orientation D2, around the mating orientation D1. The surrounding may not be limited to be a complete encirclement. For example, even if a line surrounding an object to be surrounded is missing at one or more locations, if at least a part of the object to be surrounded is included within an annular body obtained by linear interpolation of the one or more missing locations, the object to be surrounded is considered to be surrounded by the line. The same applies in the following.

Each of the plurality of shells 140 has a U-shape, with an opening portion forming the U-shape located near the circuit board 10 and a bottom portion forming the U-shape located far from the circuit board 10. For example, each of the plurality of shells 140 opens toward the circuit board 10. Each of the plurality of shells 140 has a pair of shell connection portions 143 at both ends toward the circuit board 10 (both ends in the arrangement orientation D2). The pair of shell connection portions 143 are connected to a ground pattern 13 of the circuit board 10.

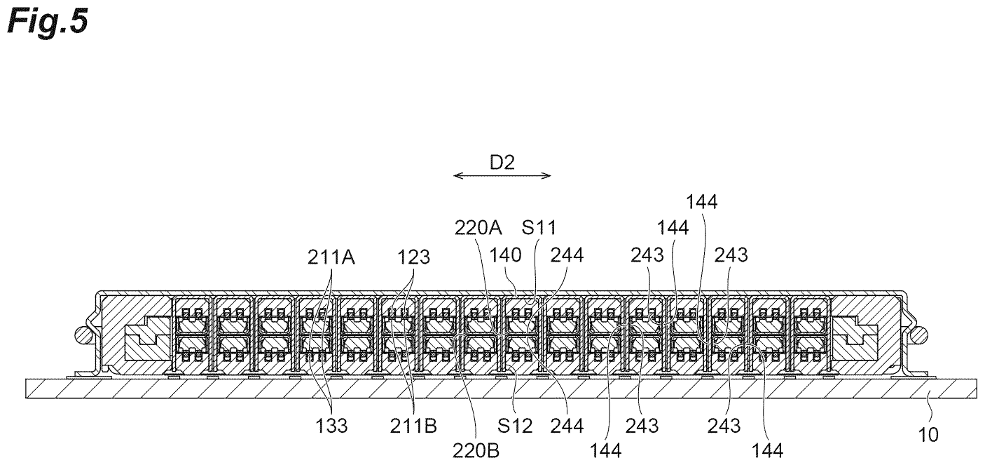

The receptacle connector 2 further includes a plurality of receiving spaces S1. The plurality of receiving spaces S1 are respectively provided within the plurality of shells 140 so as to respectively receive a plurality of conductive partition portions 244 (see FIG. 5) provided in the plug connector 3.

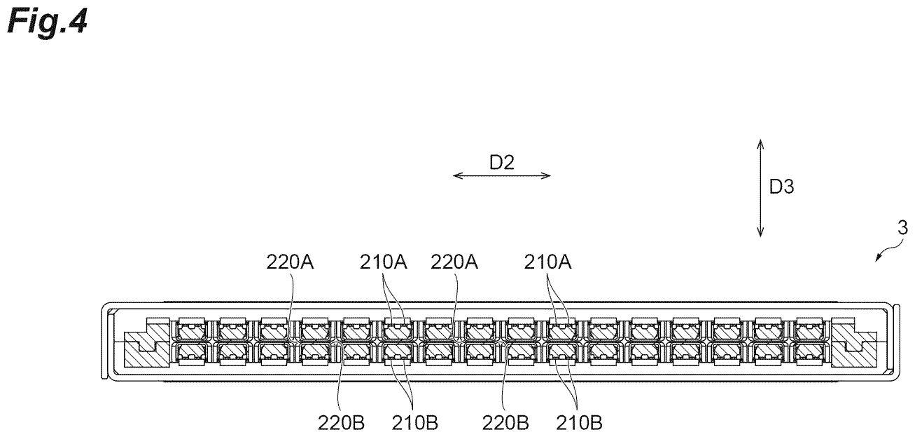

FIG. 4 is a cross-sectional view taken along line IV-IV in FIG. 1. As illustrated in FIG. 4, the plug connector 3 has a plurality of pairs of conductive first contacts 210A, a plurality of pairs of conductive second contacts 210B, a plurality of conductive first shells 220A, and a plurality of conductive second shells 220B.

The plurality of pairs of first contacts 210A are arranged along the arrangement orientation D2 and are respectively connected to the plurality of pairs of first insulated wires 30A. The plurality of pairs of second contacts 210B are arranged parallel to the plurality of pairs of first contacts 210A in the orthogonal orientation D3 and are respectively connected to the plurality of pairs of second insulated wires 30B. The plurality of first shells 220A surround the plurality of pairs of first contacts 210A pair by pair around the mating orientation D1. For example, each of the plurality of first shells 220A surrounds a pair of first contacts 210A. The plurality of second shells 220B surround the plurality of pairs of second contacts 210B pair by pair around the mating orientation D1. For example, each of the plurality of second shells 220B surrounds a pair of second contacts 210B.

The plurality of pairs of first contacts 210A in the first row are surrounded pair by pair by the plurality of first shells 220A, and the plurality of pairs of second contacts 210B in the second row are also surrounded pair by pair by the plurality of second shells 220B. Therefore, the pairs are partitioned from each other by a conductive member in both the arrangement orientation D2 and the orthogonal orientation D3 in which the first row and the second row are arranged. Accordingly, this is beneficial for improving shielding performance.

Each of the plurality of first shells 220A has a U-shape, with an opening portion forming the U-shape located near the first contacts 210A and a bottom portion forming the U-shape located far from the first contacts 210A. Each of the plurality of second shells 220B has a U-shape, with an opening portion forming the U-shape located near the second contacts 210B and a bottom portion forming the U-shape located far from the second contacts 210B. The bottom portions of the plurality of first shells 220A and the bottom portions of the plurality of second shells 220B are in contact. That is, each of the plurality of first shells 220A may open in a direction in which the plurality of pairs of first contacts 210A move away from the plurality of pairs of second contacts 210B, and each of the plurality of second shells 220B may open in a direction in which the plurality of pairs of second contacts 210B move away from the plurality of pairs of first contacts 210A. Even without providing a space between the plurality of pairs of first contacts 210A and the plurality of pairs of second contacts 210B, mutual interference due to electromagnetic waves can be suppressed by the first shells 220A and the second shells 220B, and the plurality of pairs of first contacts 210A can be brought into contact with a plurality of pairs of first contacts 120 (counterpart first contacts), and the plurality of pairs of second contacts 210B can be brought into contact with a plurality of pairs of second contacts 130 (counterpart second contacts), respectively. Therefore, both downsizing of the plug connector 3 and shielding performance may be achieved.

FIG. 5 is a cross-sectional view taken along line V-V in FIG. 2. As illustrated in FIG. 5, in a state where the plug connector 3 is mated with the receptacle connector 2, the plurality of shells 140 of the receptacle connector 2 accommodate the plurality of pairs of first contacts 210A and the plurality of second contacts 210B, one pair of first contacts 210A and one pair of second contacts 210B arranged in the orthogonal orientation D3 per shell (wherein each of the plurality of shells 140 accommodates one pair of first contacts 210A and one pair of second contacts 210B arranged in the orthogonal orientation D3). Within the shell 140 in which the pair of first contacts 210A and the pair of second contacts 210B are accommodated, the pair of first contacts 210A respectively contact the pair of first contacts 120, and the pair of second contacts 210B respectively contact the pair of second contacts 130. The first shell 220A and the second shell 220B, which respectively accommodate the pair of first contacts 210A and the pair of second contacts 210B, have a partition portion 244 that enters a receiving space S1 in the interior of the shell 140 in which the pair of first contacts 210A and the pair of second contacts 210B are accommodated. The partition portion 244 that has entered the receiving space S1 partitions the interior of the shell 140 into a first accommodation space S11 in which the pair of first contacts 210A and the pair of first contacts 120 are accommodated, and a second accommodation space S12 in which the pair of second contacts 210B and the pair of second contacts 130 are accommodated.

In this way, the interior of each of the plurality of shells 140 is partitioned by the plurality of partition portions 244 that respectively enter the plurality of receiving spaces S1 into a first accommodation space S11 that accommodates a pair of the first contacts 120 and a second accommodation space S12 that accommodates a pair of the second contacts 130. According to the receptacle connector 2, the plurality of pairs of first contacts 120 in the first row and the plurality of pairs of second contacts 130 in the second row are partitioned by the plurality of shells 140, one pair of first contacts 120 and one pair of second contacts 130 per shell (wherein each of the plurality of shells 140 partitions one pair of first contacts 120 and one pair of second contacts 130). Furthermore, the interior of each of the plurality of shells is partitioned by the plurality of partition portions 244 of the plug connector 3 into the first accommodation space S11 that accommodates the pair of first contacts 120 and the second accommodation space S12 that accommodates the pair of second contacts 130. This improves shielding performance. In addition, by using the components of the receptacle connector 2 and the components of the plug connector 3 together, the space occupied by the shield can be reduced, and more space can be allocated for signal transmission. Accordingly, this is beneficial for achieving both an increased number of signals that can be transmitted in parallel and improved shielding performance.

The partition portion 244 may include a pair of shell contact portions 243 that are oriented away from each other in the arrangement orientation D2 and contact an inner surface of the shell 140 in which they are accommodated. By improving the shielding property between the shell 140 and the partition portion 244, the shielding performance can be further improved.

The fact that the first shell 220A and the second shell 220B have the partition portion 244 means that at least one of the first shell 220A and the second shell 220B has the partition portion 244. The first shell 220A may have the partition portion 244 and the second shell 220B may not have the partition portion 244, or the second shell 220B may have the partition portion 244 and the first shell 220A may not have the partition portion 244. Each of the first shell 220A and the second shell 220B may have the partition portion 244, and the first accommodation space S11 and the second accommodation space S12 may be doubly partitioned by the partition portion 244 of the first shell 220A and the partition portion 244 of the second shell 220B. The shielding performance between the first accommodation space S11 and the second accommodation space S12 can be further improved.

Each of the plurality of shells 140 may include a pair of shell contact portions 144 that face each other in the arrangement orientation D2 so as to respectively contact the partition portion 244 that has entered the receiving space S1. The pair of shell contact portions 144 respectively contact the pair of shell contact portions 243 of the partition portion 244. When each of the first shell 220A and the second shell 220B has the partition portion 244, each of the pair of shell contact portions 144 contacts both the partition portion 244 of the first shell 220A and the partition portion 244 of the second shell 220B.

FIG. 6 is a cross-sectional view taken along line VI-VI in FIG. 2. As illustrated in FIG. 6, each of the pair of first contacts 120 of the receptacle connector 2 may have a first contact portion 123 that extends toward the circuit board 10 and contacts a first contact 210A of the plug connector 3. Each of the pair of second contacts 130 of the receptacle connector 2 may have a second contact portion 133 that extends away from the circuit board 10 and contacts a second contact 210B of the plug connector 3.

As described above, each of the first shell 220A and the second shell 220B may open such that the pair of first contacts 210A and the pair of second contacts 210B are in a positional relationship opposite to each other in the orthogonal orientation D3. For example, the first shell 220A may be arranged such that an opening portion forming the U-shape is located farther from the circuit board 10 than a bottom portion forming it, and the pair of first contacts 210A may be arranged in the opening portion of the first shell 220A. The second shell 220B may be arranged such that an opening portion forming the U-shape is located closer to the circuit board 10 than a bottom portion forming it, and the pair of second contacts 210B may be arranged in the opening portion of the second shell 220B. Each of the pair of first contacts 210A has a first contact portion 211A that contacts the first contact 120 in a direction in which the first shell 220A opens (a direction from the bottom portion forming the U-shape to the opening portion forming it), and each of the pair of second contacts 210B may have a second contact portion 211B that contacts the second contact 130 in a direction in which the second shell 220B opens (a direction from the bottom portion forming the U-shape to the opening portion forming it). Even without providing a space between the plurality of pairs of first contacts 210A and the plurality of pairs of second contacts 210B, mutual interference due to electromagnetic waves can be suppressed by the first shells 220A and the second shells 220B, and the plurality of pairs of first contacts 210A can be brought into contact with the plurality of pairs of first contacts 120, and the plurality of pairs of second contacts 210B can be brought into contact with the plurality of pairs of second contacts 130, respectively. Therefore, both downsizing of the connector and shielding performance can be achieved.

Each of the plurality of pairs of first contacts 120 of the receptacle connector 2 may further have a first connection portion 124 connected to a first signal line 11 of the circuit board 10. Each of the plurality of pairs of second contacts 130 may further have a second connection portion 134 connected to a second signal line 12 of the circuit board 10.

Each of the plurality of shells 140 may accommodate at least the first contact portion 123 and the second contact portion 133 in the mating orientation D1. Each of the plurality of shells 140 may further accommodate the first connection portion 124 and the second connection portion 134 in the mating orientation D1. The shielding performance can be further improved.

Each of the plurality of pairs of first contacts 210A of the plug connector 3 may further have a first connection portion 212A connected to a first insulated wire 30A. Each of the second contacts 210B may further have a second connection portion 212B connected to a second insulated wire 30B.

The first insulated wire 30A has a conductive signal conductor 31 and an insulating inner sheath 32 that covers the signal conductor 31. Similarly, the second insulated wire 30B also has a signal conductor 31 and an inner sheath 32. The first shielded cable 20A has a conductive outer conductor 21 that covers a pair of first insulated wires 30A, and an insulating outer sheath 22 that covers the outer conductor 21. Similarly, the second shielded cable 20B also has a conductive outer conductor 21 that covers a pair of second insulated wires 30B, and an insulating outer sheath 22 that covers the outer conductor 21.

For connection to the plug connector 3, an end of the first shielded cable 20A is formed with a first exposed portion where the signal conductor 31 of each of the pair of first insulated wires 30A is exposed, and a second exposed portion where the outer conductor 21 is exposed. The signal conductor 31 of the first exposed portion is connected to the first connection portion 212A by soldering or the like. The outer conductor 21 of the second exposed portion is connected to a first base plate 250A, which will be described later, together with the first shell 220A by soldering or the like.

Similarly, a first exposed portion and a second exposed portion are also formed at an end of the second shielded cable 20B. The signal conductor 31 of the first exposed portion is connected to the second connection portion 212B by soldering or the like. The outer conductor 21 of the second exposed portion is connected to a second base plate 250B, which will be described later, together with the second shell 220B by soldering or the like.

Returning to FIG. 1, the connector system 1 further includes a lock member 280. The lock member 280 prevents the plug connector 3 from being detached from the receptacle connector 2 in a state where the plug connector 3 is mated with the receptacle connector 2. The lock member 280 has a pair of arms 281 and a hold bar 282. The pair of arms 281 are respectively attached to both ends of the plug connector 3 in the arrangement orientation D2 so as to be rotatable around an axis 283 along the arrangement orientation D2. Each of the pair of arms 281 extends in a direction away from the axis 283. The hold bar 282 extends along the arrangement orientation D2 and connects the ends of the pair of arms 281.

After the plug connector 3 is mated with the receptacle connector 2, by rotating the pair of arms 281 around the axis 283, the hold bar 282 can be arranged behind the receptacle connector 2 as viewed from the plug connector 3, as illustrated in FIG. 2. The hold bar 282 arranged behind the receptacle connector 2 resists displacement of the plug connector 3 in a direction away from the receptacle connector 2 along the mating orientation D1, thereby preventing the plug connector 3 from being detached from the receptacle connector 2. By rotating the pair of arms 281 around the axis 283 to move the hold bar 282 away from behind the receptacle connector 2, the plug connector 3 can be detached from the receptacle connector 2.

Hereinafter, respective example configurations of the receptacle connector 2 and the plug connector 3 will be further described.

### [Receptacle Connector]

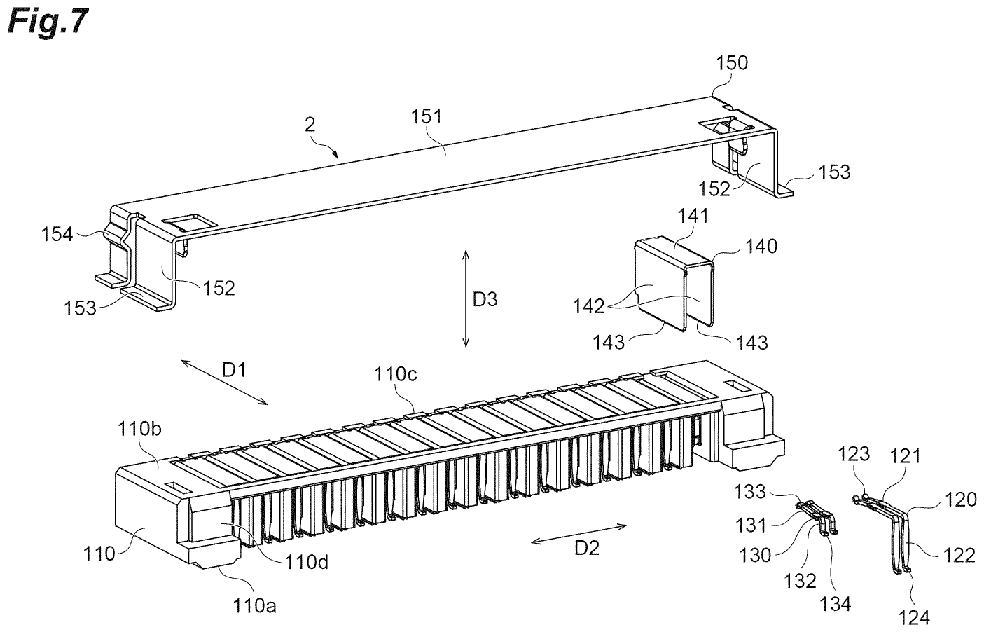

FIG. 7 is an exploded perspective view of the receptacle connector 2. As described above, the receptacle connector 2 includes the plurality of pairs of first contacts 120, the plurality of pairs of second contacts 130, and the plurality of shells 140. However, FIG. 7 illustrates a state in which one pair of first contacts 120, one pair of second contacts 130, and one shell 140 are removed.

As illustrated in FIG. 7, the receptacle connector 2 includes a housing 110, the plurality of pairs of first contacts 120, the plurality of pairs of second contacts 130, the plurality of shells 140, and an outer cover 150. The housing 110 is formed of an insulating material such as resin and holds the plurality of pairs of first contacts 120, the plurality of pairs of second contacts 130, and the plurality of shells 140 in a state of being insulated from each other. The housing 110 has a facing surface 110a facing the circuit board 10, an opposite surface 110b facing away from the circuit board 10, a front surface 110c facing the plug connector 3 along the mating orientation D1, and a rear surface 110d facing away from the plug connector 3 along the mating orientation D1.

Each of the plurality of pairs of first contacts 120 is formed of a metal material such as copper and has a first insertion portion 121 and a first leg portion 122. The first insertion portion 121 is inserted into the housing 110 from the rear surface 110d toward the front surface 110c. The above-described first contact portion 123 is formed at an end of the first insertion portion 121 that is inserted into the housing 110. The first leg portion 122 is bent with respect to the first insertion portion 121 and extends toward the circuit board 10. The above-described first connection portion 124 is formed at an end of the first leg portion 122.

Each of the plurality of pairs of second contacts 130 is formed of a metal material such as copper and has a second insertion portion 131 and a second leg portion 132. The second insertion portion 131 is inserted into the housing 110 from the rear surface 110d toward the front surface 110c. The above-described second contact portion 133 is formed at an end of the second insertion portion 131 inserted into the housing 110. The second leg portion 132 is bent with respect to the second insertion portion 131 and extends toward the circuit board 10. The above-described second connection portion 134 is formed at an end of the second leg portion 132. The second insertion portion 131 is located between the first insertion portion 121 and the circuit board 10. The second connection portion 134 is arranged forward of the first connection portion 124. For this reason, the length of the second insertion portion 131 is shorter than the length of the first insertion portion 121, and the length of the second leg portion 132 is shorter than the length of the first leg portion 122.

Each of the plurality of shells 140 is formed of a metal material such as copper and has a center plate 141 and a pair of partition plates 142. The center plate 141 faces the opposite surface 110b. The pair of partition plates 142 are respectively bent with respect to the center plate 141, extend toward the circuit board 10, and face each other along the arrangement orientation D2. The above-described shell connection portion 143 is formed at an end of each of the pair of partition plates 142 that faces the circuit board 10.

Each of the pair of partition plates 142 is inserted into the housing 110 from the opposite surface 110b toward the facing surface 110a, partitions between two adjacent pairs of first contacts 120, and also partitions between two adjacent pairs of second contacts 130. The shell connection portion 143 reaches the facing surface 110a so as to be connectable to the ground pattern 13.

The outer cover 150 is formed of a metal material such as copper and at least partially covers an outer surface of the housing 110. For example, the outer cover 150 has a cover plate 151 and a pair of side plates 152. The cover plate 151 covers the opposite surface 110b from outside the center plates 141 of the plurality of shells 140. The pair of side plates 152 respectively extend from both ends of the cover plate 151 in the arrangement orientation D2 toward the circuit board 10 and cover both end surfaces of the housing 110 in the arrangement orientation D2.

A cover connection portion 153 connected to the ground pattern 13 of the circuit board 10 is formed at an end of each of the pair of side plates 152 that faces the circuit board 10. Each of the pair of side plates 152 is formed with a protrusion 154 that protrudes in a direction away from the housing 110 along the arrangement orientation D2. The protrusions 154 of the pair of side plates 152 respectively catch on the pair of arms 281 in a state where the hold bar 282 of the lock member 280 is arranged behind the receptacle connector 2 as described above, thereby preventing the lock member 280 from being detached.

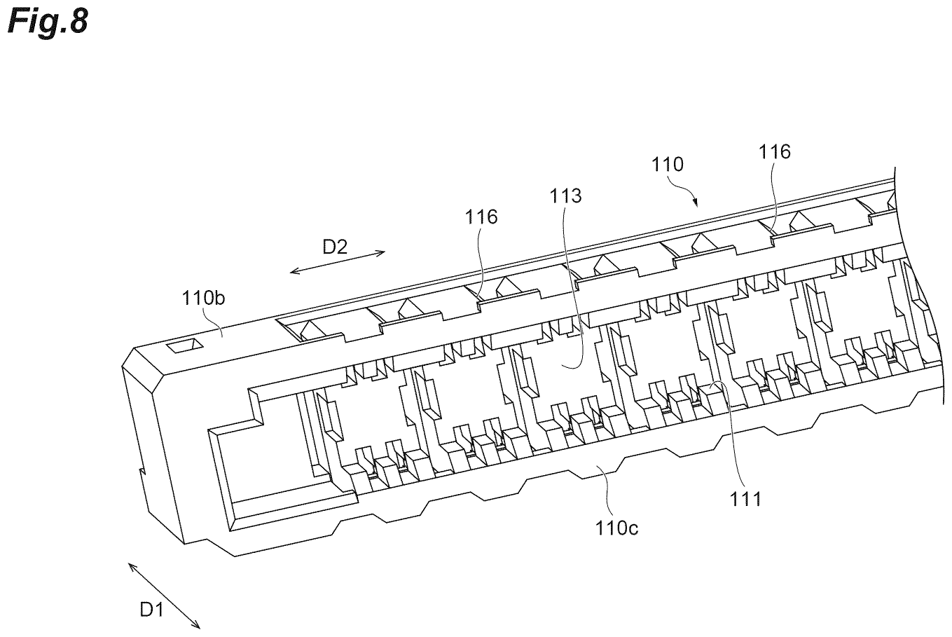

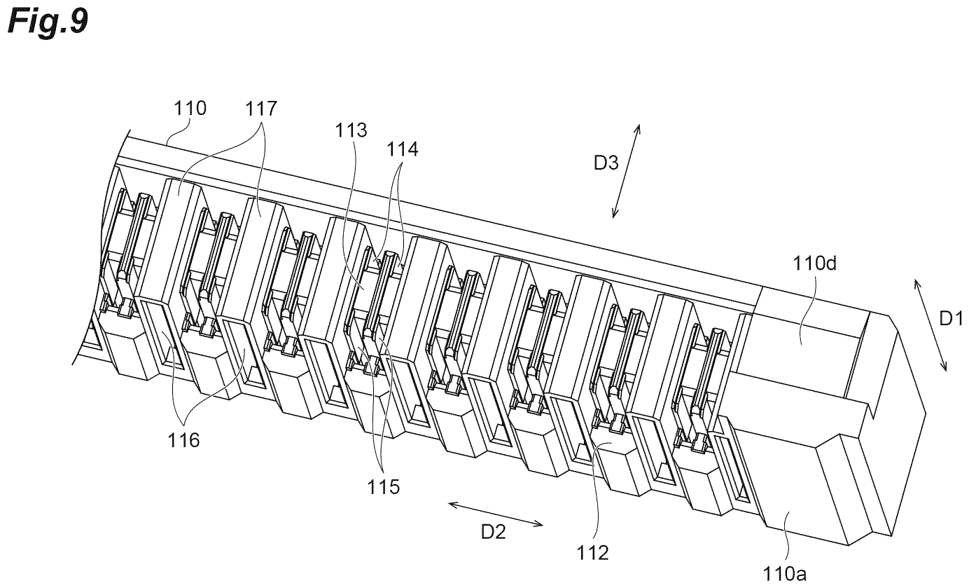

FIG. 8 is a perspective view of the housing 110 alone viewed from the front surface 110c and the opposite surface 110b, and similarly, FIG. 9 is a perspective view viewed from the facing surface 110a and the rear surface 110d. As illustrated in FIGS. 8 and 9, the housing 110 has a mating hole 111, a connection space 112, and a holding wall 113. As illustrated in FIG. 8, the mating hole 111 opens along the mating orientation D1 toward the plug connector 3. For example, the mating hole 111 opens on the front surface 110c and extends along the arrangement orientation D2. As illustrated in FIG. 9, the connection space 112 opens along the mating orientation D1 in a direction away from the mating hole 111, and further opens toward the circuit board 10. For example, the connection space 112 opens on the rear surface 110d and the facing surface 110a and extends along the arrangement orientation D2. The holding wall 113 partitions between the mating hole 111 and the connection space 112 and holds the plurality of pairs of first contacts 120 and the plurality of pairs of second contacts 130. For example, the holding wall 113 has a plurality of pairs of first insertion holes 114 arranged along the arrangement orientation D2, and a plurality of pairs of second insertion holes 115 arranged along the arrangement orientation D2 between the plurality of pairs of first insertion holes 114 and the facing surface 110a.

The first insertion portions 121 of the plurality of pairs of first contacts 120 are respectively inserted into the plurality of pairs of first insertion holes 114 from the rear surface 110d toward the front surface 110c. The first contact portion 123 at the end of the first insertion portion 121 is accommodated in the mating hole 111. The first leg portion 122 and the first connection portion 124 at the end of the first leg portion 122 are accommodated in the connection space 112.

The second insertion portions 131 of the plurality of pairs of second contacts 130 are respectively inserted into the plurality of pairs of second insertion holes 115 from the rear surface 110d toward the front surface 110c. The second contact portion 133 at the end of the second insertion portion 131 is accommodated in the mating hole 111. The second leg portion 132 and the second connection portion 134 at the end of the second leg portion 132 are accommodated in the connection space 112.

The housing 110 further has a plurality of partition holes 116 arranged along the arrangement orientation D2. Each of the plurality of partition holes 116 extends through between the facing surface 110a and the opposite surface 110b. The partition holes 116 at both ends in the arrangement orientation D2 respectively receive the partition plates 142 located at both ends in the arrangement of the plurality of shells 140. Each of the partition holes 116 other than the partition holes 116 at both ends receives the overlapping partition plates 142 between adjacent shells 140 (see FIG. 7). In this way, the plurality of shells 140 accommodated in the plurality of partition holes 116 partition each of the mating hole 111, the connection space 112, and the holding wall 113 into sections so that each of the sections corresponds to one pair of first contacts 120 and one pair of second contacts 130 arranged in the orthogonal orientation D3. By partitioning the space from the mating hole 111 accommodating the first contact portion 123 and the second contact portion 133 to the connection space 112 accommodating the first connection portion 124 and the second connection portion 134 for each pair of first contacts 120 and each pair of second contacts 130 arranged in the orthogonal orientation D3 by the plurality of shells 140, the shielding performance can be further improved.

In each of the plurality of shells 140, the above-described receiving space S1 is formed between portions of the pair of partition plates 142 located in the mating hole 111. At least a part of the portions of the pair of partition plates 142 located in the mating hole 111 serves as the pair of shell contact portions 144.

The housing 110 may further have a plurality of reinforcing walls 117 arranged along the arrangement orientation D2. The plurality of reinforcing walls 117 protrude from the holding wall 113 toward the rear surface 110d so as to partition the inside of the connection space 112 for each pair of first contacts 120 and each pair of second contacts 130 arranged in the orthogonal orientation D3. The partition holes 116 other than the partition holes 116 at both ends are respectively formed in the plurality of reinforcing walls 117.

In the mating orientation D1, the second connection portion 134 is located between the first connection portion 124 and the holding wall 113 (see FIG. 6). Lengths of portions of the plurality of pairs of second contacts 130 that are accommodated in the mating hole 111 may be longer than lengths of portions of the plurality of pairs of second contacts 130 that are accommodated in the connection space 112. By shortening the section where the first contact 120 and the second contact 130 coexist in the same space without being partitioned by the partition portion 244, the shielding performance can be further improved.

The receptacle connector 2 can be assembled, for example, by the following procedure. First, the second insertion portions 131 of the plurality of pairs of second contacts 130 are respectively inserted into the plurality of pairs of second insertion holes 115 of the housing 110 from the rear surface 110d toward the front surface 110c, the second contact portions 133 of the plurality of pairs of second contacts 130 are accommodated in the mating hole 111, and the second connection portions 134 of the plurality of pairs of second contacts 130 are accommodated in the connection space 112. Next, the first insertion portions 121 of the plurality of pairs of first contacts 120 are respectively inserted into the plurality of pairs of first insertion holes 114 of the housing 110 from the rear surface 110d toward the front surface 110c, the first contact portions 123 of the plurality of pairs of first contacts 120 are accommodated in the mating hole 111, and the first connection portions 124 of the plurality of pairs of first contacts 120 are accommodated in the connection space 112. Next, the plurality of shells 140 are respectively inserted into the plurality of partition holes 116 from the opposite surface 110b toward the facing surface 110a. Thereafter, the outer cover 150 is placed over the housing 110 from the opposite surface 110b toward the facing surface 110a.

### [Plug Connector]

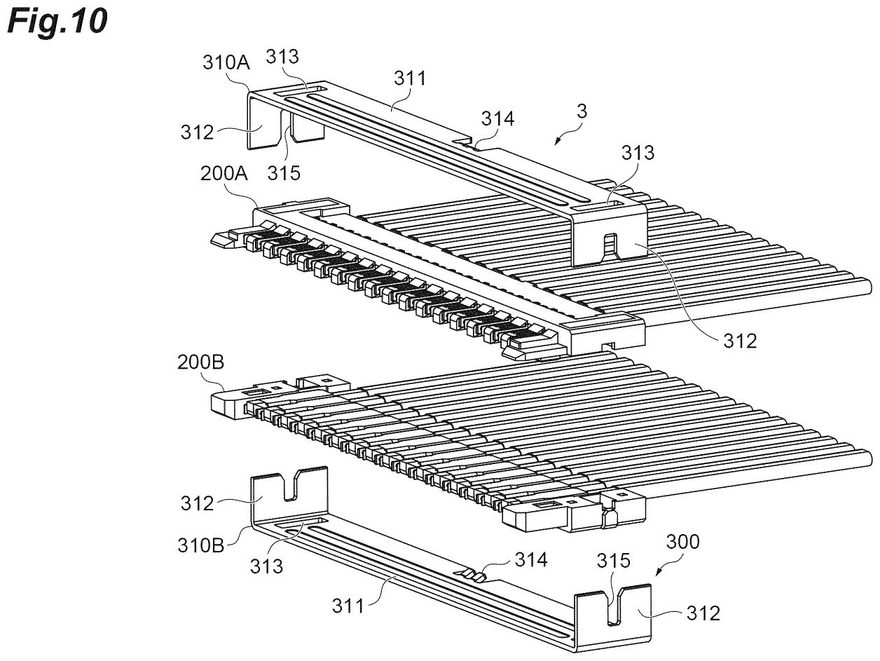

FIG. 10 is an exploded perspective view of the plug connector 3. As illustrated in FIG. 10, the plug connector 3 has a first connector 200A, a second connector 200B, and a conductive cover 300. The first connector 200A is a unitized version of the above-described plurality of pairs of first contacts 210A and the plurality of first shells 220A. The second connector 200B is a unitized version of the above-described plurality of pairs of second contacts 210B and the plurality of second shells 220B. The first connector 200A and the second connector 200B overlap in the orthogonal orientation D3. The cover 300 surrounds the overlapped first connector 200A and second connector 200B and integrates the first connector 200A and the second connector 200B. The first connector 200A and the second connector 200B, in the overlapped state, mate with the receptacle connector 2 along the mating orientation D1.

Hereinafter, the respective configurations will be described. In the description of each configuration, a direction toward the plug connector 3 along the mating orientation D1 is referred to as “front”. In the description of the first connector 200A, a direction toward the second connector 200B is referred to as “inward”, and a direction away from the second connector 200B is referred to as “outward”. In the description of the second connector 200B, a direction toward the first connector 200A is referred to as “inward”, and a direction away from the first connector 200A is referred to as “outward”.

### (First Connector)

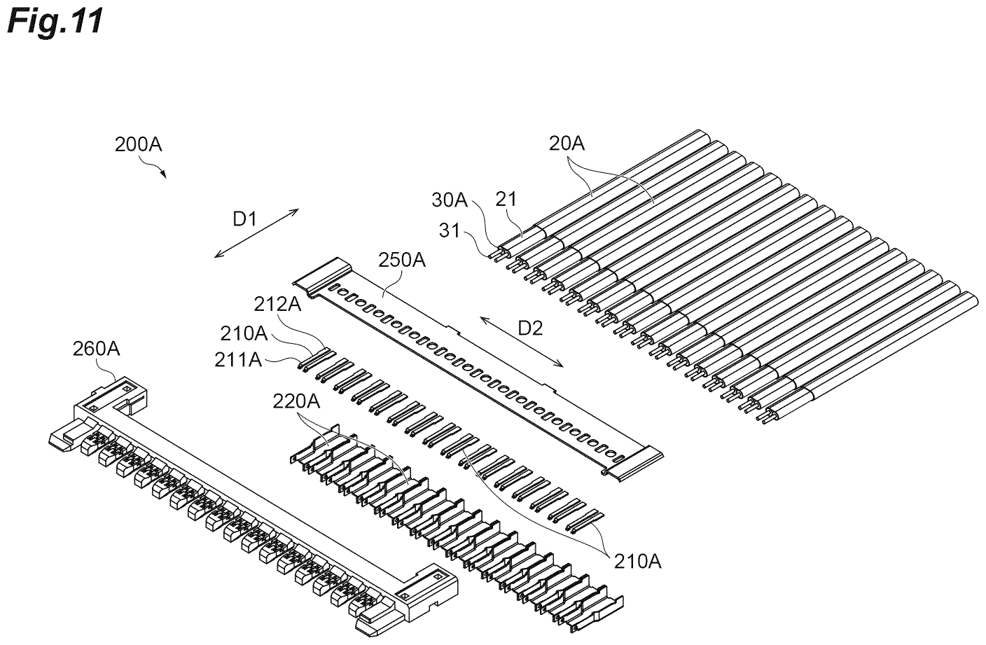

FIG. 11 is an exploded perspective view of the first connector. As illustrated in FIG. 11, the first connector 200A has the plurality of pairs of first contacts 210A, a first housing 260A, a first base plate 250A, and the plurality of first shells 220A. Each of the plurality of pairs of first contacts 210A arranged along the arrangement orientation D2 is formed of a metal material such as copper and extends along the mating orientation D1. The above-described first contact portion 211A is formed at a tip portion of the first contact 210A extending forward. The above-described first connection portion 212A is formed at a base end portion of the first contact 210A extending rearward.

The first housing 260A is formed of an insulating material such as resin. The first housing 260A extends along the arrangement orientation D2 and holds the plurality of first contacts 210A. The first housing 260A exposes the first contact portions 211A of the plurality of pairs of first contacts 210A outward, and exposes the first connection portions 212A of the plurality of pairs of first contacts 210A inward. The signal conductors 31 of the plurality of pairs of first insulated wires 30A are connected to the first connection portions 212A of the plurality of pairs of first contacts 210A from the inward side by soldering or the like.

The first base plate 250A is formed of a metal material such as copper, extends along the arrangement orientation D2, and is connected to the outer conductors 21 of the plurality of first shielded cables 20A from the outward side. The first base plate 250A is held by the first housing 260A in a state of being insulated from the plurality of first contacts 210A.

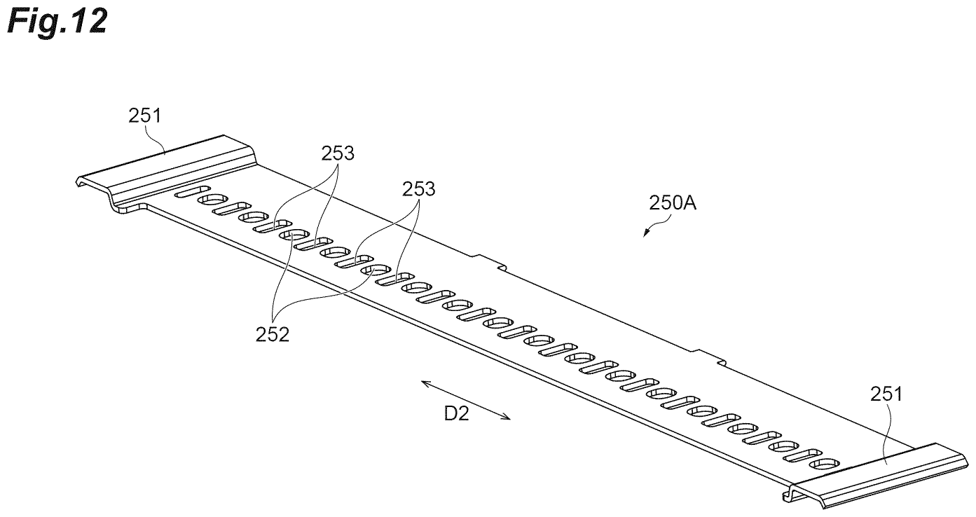

As illustrated in FIG. 12, the first base plate 250A has a pair of base connection portions 251 at both ends in the arrangement orientation D2. Each of the pair of base connection portions 251 is held by the first base plate 250A so as to be exposed outward, and is connected to the cover 300. The first base plate 250A has, between the pair of base connection portions 251, a plurality of openings 252 and a plurality of pairs of openings 253 arranged along the arrangement orientation D2. The plurality of openings 252 correspond to the plurality of first shielded cables 20A. Each of the plurality of openings 252 is open so as to expose the outer conductor 21 of the corresponding first shielded cable 20A outward. The first base plate 250A is connected to the plurality of first shielded cables 20A from the outward side by soldering or the like via the plurality of openings 252.

The plurality of pairs of openings 253 respectively correspond to the plurality of first shielded cables 20A and respectively correspond to the plurality of openings 252. Each of the plurality of pairs of openings 253 is formed such that the corresponding opening 252 is located between the opening 253 and the opening 253 in the arrangement orientation D2. The plurality of pairs of openings 253 are used to connect the plurality of first shells 220A to the first base plate 250A, as will be described later.

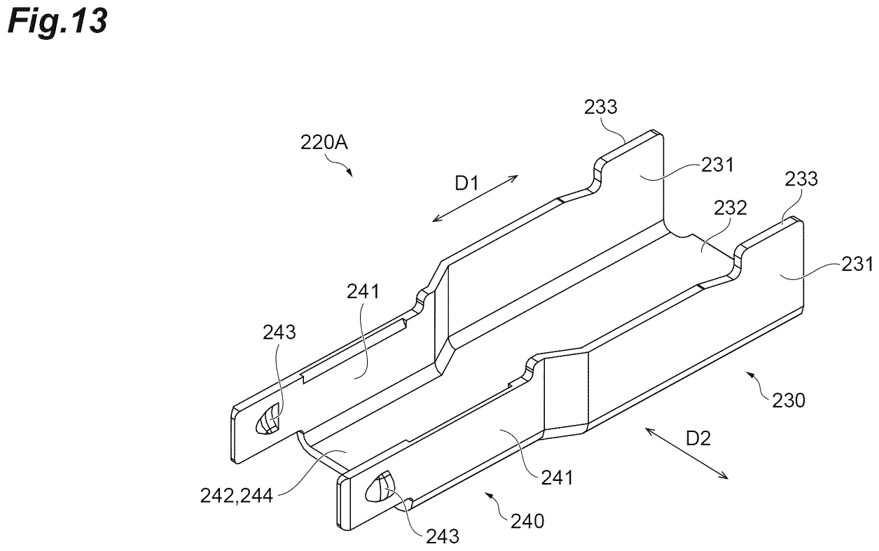

As illustrated in FIG. 13, each of the plurality of first shells 220A has a base portion 230 and an end portion 240. The base portions 230 of the plurality of first shells 220A respectively surround the outer conductors 21 of the plurality of first shielded cables 20A and are fixed to the first base plate 250A. For example, the base portion 230 has a pair of base side wall portions 231 and a base interconnecting wall portion 232. The base interconnecting wall portion 232 faces the first base plate 250A from the inward side. The pair of base side wall portions 231 are respectively bent with respect to the base interconnecting wall portion 232, extend toward the first base plate 250A, and face each other along the arrangement orientation D2. The shielded cable 20 of the corresponding first shielded cable 20A is accommodated between the pair of base side wall portions 231.

A fixing piece 233 is formed at an end of each of the pair of base side wall portions 231 that faces the first base plate 250A. The fixing pieces 233 of the pair of base side wall portions 231 respectively enter the pair of openings 253 and are fixed (connected) to the first base plate 250A from the outward side by soldering or the like. As a result, the first shell 220A is held by the first housing 260A via the first base plate 250A.

The end portion 240 extends forward from the base portion 230 along the mating orientation D1 and surrounds the pair of first contacts 210A. For example, the end portion 240 has a pair of end side wall portions 241 and an end interconnecting wall portion 242. The end interconnecting wall portion 242 is continuous with the base interconnecting wall portion 232. The pair of end side wall portions 241 are bent with respect to the end interconnecting wall portion 242, extend outward, and are respectively continuous with the pair of base side wall portions 231. The pair of end side wall portions 241 face each other along the arrangement orientation D2.

Compared to the interval between the pair of base side wall portions 231 in the arrangement orientation D2, the interval between the pair of end side wall portions 241 in the arrangement orientation D2 is smaller. The outer conductor 21 of the first shielded cable 20A exists in the base portion 230, whereas the outer conductor 21 of the first shielded cable 20A does not exist in the end portion 240. By making the interval between the pair of end side wall portions 241 at a position where the outer conductor 21 does not exist smaller than the interval between the pair of base side wall portions 231 at a position where the outer conductor 21 exists, the uniformity of the arrangement relationship between the pair of first insulated wires 30A and a metal body at ground potential surrounding the pair of first insulated wires 30A can be improved, and the signal transmission characteristics can be further improved.

The pair of end side wall portions 241 respectively have a pair of shell contact portions 243. The pair of shell contact portions 243 elastically deform and approach each other upon application of an external force, and move away from each other upon removal of the external force. At least a part of the end portion 240 enters the above-described receiving space S1 and becomes the partition portion 244. The pair of shell contact portions 243 contact inner surfaces of the pair of partition plates 142. Portions of the pair of partition plates 142 that respectively contact the pair of shell contact portions 243 serve as the pair of shell contact portions 144.

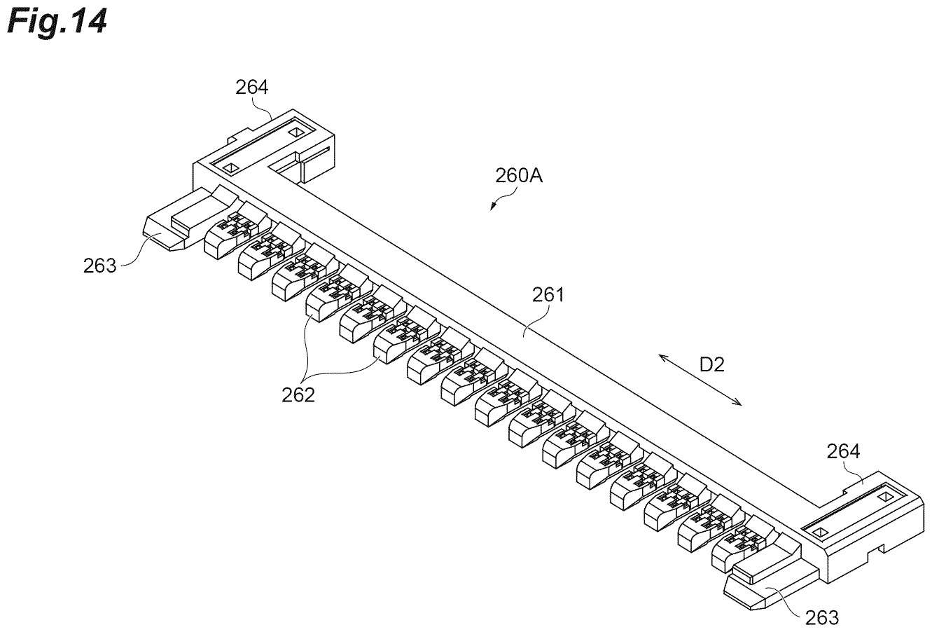

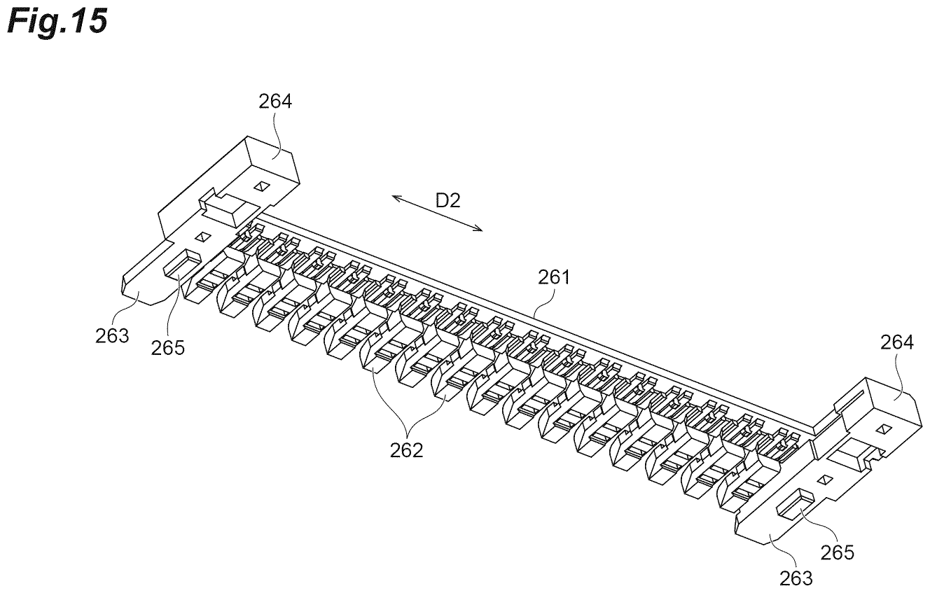

As illustrated in FIGS. 14 and 15, the first housing 260A has a first housing base 261, a plurality of first protruding portions 262, a pair of first base holding portions 264, and a pair of first guides 263. The first housing base 261 extends along the arrangement orientation D2. The plurality of first protruding portions 262 are arranged along the arrangement orientation D2 and protrude forward and inward from the first housing base 261. The plurality of first protruding portions 262 hold the plurality of pairs of first contacts 210A pair by pair and are respectively accommodated in the plurality of first shells 220A. Each of the plurality of first protruding portions 262 holds the pair of first contacts 210A such that the first contact portions 211A are exposed outward, and enters the end portion 240 of the first shell 220A from the outward side. The first connection portions 212A of the pair of first contacts 210A protrude rearward from the first protruding portion 262 and are located inward of the first housing base 261 (see FIG. 6).

The pair of first base holding portions 264 protrude inward and rearward from both ends of the first housing base 261 in the arrangement orientation D2, and respectively hold both ends of the first base plate 250A such that the pair of base connection portions 251 are exposed outward. The pair of first guides 263 respectively protrude forward from the pair of first base holding portions 264. In the arrangement orientation D2, the plurality of first protruding portions 262 are located between the pair of first guides 263. The pair of first guides 263 protrude further forward than the plurality of first protruding portions 262. When mating the plug connector 3 with the receptacle connector 2, the pair of first guides 263 enter the plug connector 3 before the plurality of first protruding portions 262 and guide the plurality of first protruding portions 262 into the plug connector 3.

The first housing 260A has a first mating portion 265 that faces a second housing 260B, which will be described later. For example, the first housing 260A has, as the first mating portion 265, a pair of protrusions respectively formed on the pair of first guides 263 so as to protrude inward.

### (Second Connector)

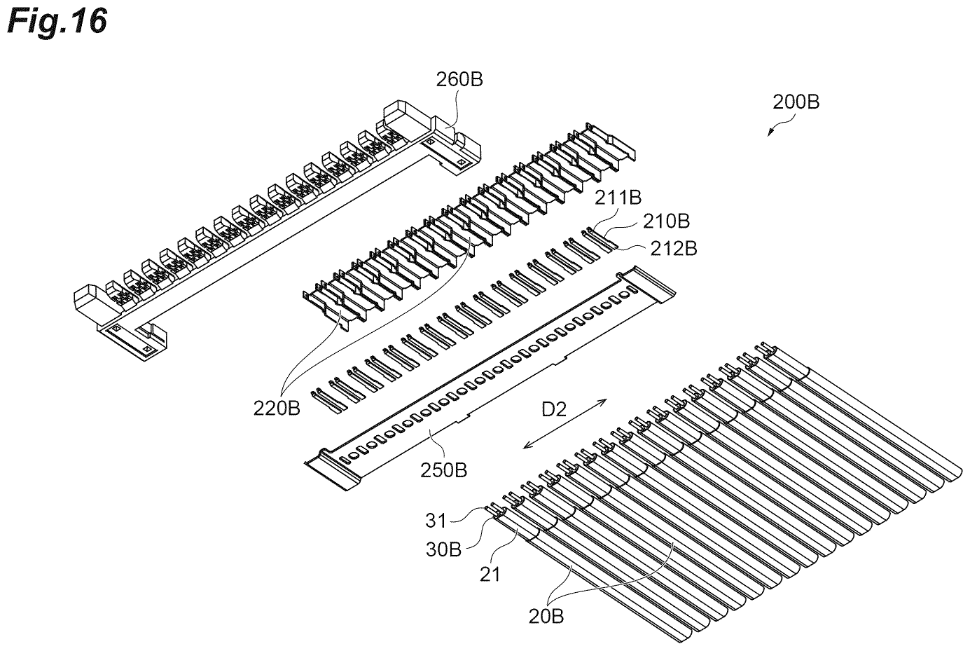

FIG. 16 is an exploded perspective view of the second connector. As illustrated in FIG. 16, the second connector 200B has the plurality of pairs of second contacts 210B, a second housing 260B, a second base plate 250B, and the plurality of second shells 220B. The structure of the second connector 200B is the same as the structure of the first connector 200A, with the plurality of pairs of second contacts 210B corresponding to the plurality of pairs of first contacts 210A in the first connector 200A, the second housing 260B corresponding to the first housing 260A in the first connector 200A, and the second base plate 250B corresponding to the first base plate 250A in the first connector 200A. The plurality of second shells 220B correspond to the plurality of first shells 220A in the first connector 200A. Each of the plurality of pairs of second contacts 210B is the same component as each of the plurality of pairs of first contacts 210A, and the above-described second contact portion 211B is formed at a tip portion of the second contact 210B extending forward. The above-described second connection portion 212B is formed at a base end portion of the second contact 210B extending rearward. The second base plate 250B is the same component as the first base plate 250A, and each of the plurality of second shells 220B is the same component as each of the plurality of first shells 220A.

The function of the second housing 260B in the second connector 200B is common to the function of the first housing 260A in the first connector 200A, but the second housing 260B is not the same component as the first housing 260A. The second housing 260B is formed of an insulating material such as resin. The second housing 260B extends along the arrangement orientation D2 and holds the plurality of second contacts 210B. The second housing 260B exposes the second contact portions 211B of the plurality of pairs of second contacts 210B outward, and exposes the second connection portions 212B of the plurality of pairs of second contacts 210B inward. The signal conductors 31 of the plurality of pairs of second insulated wires 30B are connected to the second connection portions 212B of the plurality of pairs of second contacts 210B from the inward side by soldering or the like.

The second base plate 250B is held by the second housing 260B in a state of being insulated from the plurality of second contacts 210B, and is connected to the outer conductors 21 of the plurality of second shielded cables 20B from the outward side.

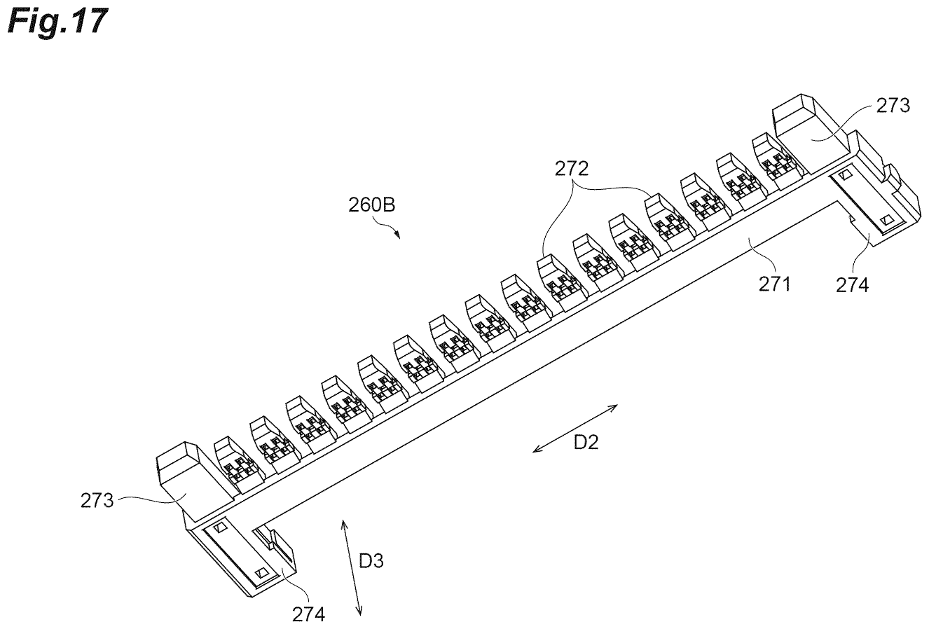

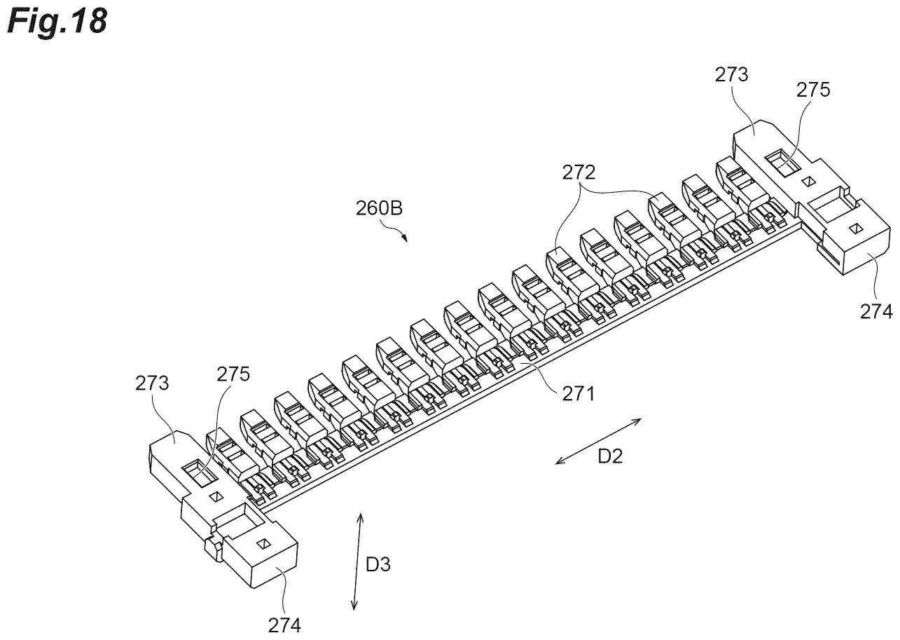

As illustrated in FIGS. 17 and 18, the second housing 260B, similarly to the first housing 260A, has a second housing base 271, a plurality of second protruding portions 272, a pair of second base holding portions 274, and a pair of second guides 273. The second housing base 271 extends along the arrangement orientation D2. The plurality of second protruding portions 272 are arranged along the arrangement orientation D2 and protrude forward and inward from the second housing base 271. The plurality of second protruding portions 272 hold the plurality of pairs of second contacts 210B pair by pair and are respectively accommodated in the plurality of second shells 220B. Each of the plurality of second protruding portions 272 holds the pair of second contacts 210B such that the second contact portions 211B are exposed outward, and enters the end portion 240 of the second shell 220B from the outward side. The second connection portions 212B of the pair of second contacts 210B protrude rearward from the second protruding portion 272 and are located inward of the second housing base 271 (see FIG. 6).

The pair of second base holding portions 274 protrude inward and rearward from both ends of the second housing base 271 in the arrangement orientation D2, and respectively hold both ends of the second base plate 250B such that the pair of second housing bases 271 are exposed outward. The pair of second guides 273 respectively protrude forward from the pair of second base holding portions 274. In the arrangement orientation D2, the plurality of second protruding portions 272 are located between the pair of second guides 273. The pair of second guides 273 protrude further forward than the plurality of second protruding portions 272. When mating the plug connector 3 with the receptacle connector 2, the pair of second guides 273 enter the plug connector 3 before the plurality of second protruding portions 272 and guide the plurality of second protruding portions 272 into the plug connector 3.

In the orthogonal orientation D3, the thickness of the pair of second guides 273 is different from the thickness of the pair of first guides 263. For example, the thickness of the pair of second guides 273 in the orthogonal orientation D3 is greater than the thickness of the pair of first guides 263 in the orthogonal orientation D3.

The second housing 260B has a second mating portion 275 that faces the first housing 260A. For example, the second housing 260B has, as the second mating portion 275, a pair of recesses respectively formed in the pair of second guides 273 so as to open inward, and the pair of protrusions that are the first mating portion 265 respectively mate with the pair of recesses that are the second mating portion 275. The first mating portion 265 may be a recess and the second mating portion 275 may be a protrusion.

### (Outer Cover)

Returning to FIG. 10, the cover 300 has a first outer cover 310A and a second outer cover 310B. The first outer cover 310A is formed of a metal material such as copper and has a cover plate 311 and a pair of side plates 312. The cover plate 311 extends along the arrangement orientation D2 and covers the first housing 260A from the outward side.

The pair of side plates 312 are continuous with both ends of the cover plate 311 in the arrangement orientation D2 and respectively cover both end surfaces of the first housing 260A and the second housing 260B in the arrangement orientation D2. The cover plate 311 has a pair of connection openings 313 respectively near both ends in the arrangement orientation D2. The pair of connection openings 313 respectively expose the pair of base connection portions 251 of the first base plate 250A outward. The cover plate 311 is fixed (connected) to the pair of base connection portions 251 of the first base plate 250A from the outward side by soldering or the like via the pair of connection openings 313.

The cover plate 311 may further have a cover connection portion 314 that contacts the first base plate 250A between the pair of connection openings 313. The cover connection portion 314 extends inward between the pair of connection openings 313 and contacts the first base plate 250A.

The pair of side plates 312 are respectively provided with a pair of bearing slits 315. The pair of bearing slits 315 open in a direction away from the cover plate 311.

The second outer cover 310B, similarly to the first outer cover 310A, is formed of a metal material such as copper and has a cover plate 311 and a pair of connection openings 313. The cover plate 311 extends along the arrangement orientation D2 and covers the second housing 260B from the outward side.

The pair of side plates 312 are continuous with both ends of the cover plate 311 in the arrangement orientation D2, respectively overlap with the pair of side plates 312 of the first outer cover 310A in the arrangement orientation D2, and are respectively fixed (connected) to the pair of side plates 312 of the first outer cover 310A by soldering or the like. The cover plate 311 has a pair of connection openings 313 respectively near both ends in the arrangement orientation D2. The pair of connection openings 313 respectively expose the pair of base connection portions 251 of the second base plate 250B outward. The cover plate 311 is fixed (connected) to the pair of base connection portions 251 of the second base plate 250B from the outward side by soldering or the like via the pair of connection openings 313.

The cover plate 311 may further have a cover connection portion 314 that contacts the second base plate 250B between the pair of connection openings 313. The cover connection portion 314 extends inward between the pair of connection openings 313 and contacts the second base plate 250B.

The pair of side plates 312 are respectively provided with a pair of bearing slits 315. The pair of bearing slits 315 open in a direction away from the cover plate 311. The pair of bearing slits 315 of the second outer cover 310B and the pair of bearing slits 315 of the first outer cover 310A form bearing holes for the pair of arms 281 of the lock member 280.

The second outer cover 310B may be the same component as the first outer cover 310A. The pair of side plates 312 of the second outer cover 310B and the pair of side plates 312 of the first outer cover 310A overlap so as to be alternately arranged in the arrangement orientation D2 (see FIG. 4).

### (Assembly Procedure)

The plug connector 3 can be assembled by the following procedure. First, a first unit in which the plurality of pairs of first contacts 210A, the first base plate 250A, and the first housing 260A are integrated is formed by insert molding of a resin material or the like. Similarly, a second unit in which the plurality of pairs of second contacts 210B, the second base plate 250B, and the second housing 260B are integrated is formed by insert molding of a resin material or the like. Next, the signal conductors 31 of the plurality of pairs of first insulated wires 30A are respectively connected to the plurality of pairs of first contacts 210A of the first unit. Similarly, the signal conductors 31 of the plurality of pairs of second insulated wires 30B are respectively connected to the plurality of pairs of second contacts 210B of the second unit. Next, the plurality of first shells 220A are attached to the first unit so as to surround the plurality of pairs of first contacts 210A to which the signal conductors 31 of the plurality of pairs of first insulated wires 30A are respectively connected, one pair of first contacts 210A per shell (wherein each of the plurality of first shells 220A surrounds one pair of first contacts 210A). Similarly, the plurality of second shells 220B are attached to the second unit so as to surround the plurality of pairs of second contacts 210B to which the signal conductors 31 of the plurality of pairs of second insulated wires 30B are respectively connected, one pair of second contacts per shell (wherein each of the plurality of second shells 220B surrounds one pair of second contacts 210B). Next, the first housing 260A and the second housing 260B are combined and integrated by the cover 300 such that the plurality of pairs of first contacts 210A and the plurality of pairs of second contacts 210B are arranged parallel to each other in the orthogonal orientation D3. Next, the lock member 280 is attached to the plug connector 3.

The above disclosure includes the following configurations.

(1) A connector 3 configured to be connected to a plurality of pairs of first insulated wires 30A and a plurality of pairs of second insulated wires 30B and to mate with a counterpart connector 2 along a mating orientation D1, the connector 3 comprising: a plurality of pairs of conductive first contacts 210A arranged along an arrangement orientation D2 perpendicular to the mating orientation D1 and configured to be respectively connected to the plurality of pairs of first insulated wires 30A; a plurality of pairs of conductive second contacts 210B arranged parallel to the plurality of pairs of first contacts 210A in an orthogonal orientation D3 perpendicular to the mating orientation D1 and the arrangement orientation D2, and configured to be respectively connected to the plurality of pairs of second insulated wires 30B; a plurality of conductive first shells 220A surrounding the plurality of pairs of first contacts 210A pair by pair around the mating orientation D1; and a plurality of conductive second shells 220B surrounding the plurality of pairs of second contacts 210B pair by pair around the mating orientation D1.

In a configuration in which a plurality of pairs of contacts are arranged in two rows, the plurality of pairs of first contacts 210A in a first row are surrounded pair by pair by the plurality of first shells 220A, and the plurality of pairs of second contacts 210B in a second row are also surrounded pair by pair by the plurality of second shells 220B. Therefore, the pairs are partitioned from each other by a conductive member in both the arrangement orientation D2 and a direction in which the first row and the second row are arranged. Accordingly, this is beneficial for improving shielding performance.

(2) The connector 3 according to (1), wherein each of the plurality of first shells 220A comprises an opening oriented away from the plurality of pairs of second contacts 210B, and wherein each of the plurality of second shells 220B comprises an opening oriented away from the plurality of pairs of first contacts 210A.

Even without providing a space between the plurality of pairs of first contacts 210A and the plurality of pairs of second contacts 210B, mutual interference due to electromagnetic waves can be suppressed by the first shells 220A and the second shells 220B, and the plurality of pairs of first contacts 210A can be brought into contact with a plurality of pairs of counterpart first contacts 120, and the plurality of pairs of second contacts 210B can be brought into contact with a plurality of pairs of counterpart second contacts 130, respectively. Therefore, both downsizing of the connector 3 and shielding performance can be achieved.

(3) The connector 3 according to (1) or (2), wherein the counterpart connector 2 comprises: a plurality of pairs of conductive counterpart first contacts 120, wherein the plurality of pairs of first contacts 210A respectively contact the plurality of pairs of counterpart first contacts 120 in a mated state where the connector 3 is mated with the counterpart connector 2; a plurality of pairs of conductive counterpart second contacts 130, wherein the plurality of pairs of second contacts 210B respectively contact the plurality of pairs of counterpart second contacts 130 in the mated state; and a plurality of counterpart shells surrounding the plurality of pairs of counterpart first contacts 120 and the plurality of pairs of counterpart second contacts 130, one pair of counterpart first contacts 120 and one pair of counterpart second contacts 130 per counterpart shell, wherein the plurality of counterpart shells are configured to accommodate the plurality of pairs of first contacts 210A and the plurality of second contacts 210B, one pair of first contacts 210A and one pair of second contacts 210B per counterpart shell in the mated state, and wherein a first shell 220A surrounding the pair of first contacts 210A and a second shell 220B surrounding the pair of second contacts 210B are accommodated in the counterpart shell in the mated state and comprise a partition portion 244 that partitions an interior of the counterpart shell into a first accommodation space S11 and a second accommodation space S12, wherein the pair of first contacts 210A and the pair of counterpart first contacts 120 are accommodated in the first accommodation space S11, and the pair of second contacts 210B and the pair of counterpart second contacts 130 are accommodated in the second accommodation space S12.

In cooperation with the counterpart shells, the shielding performance can be further improved.

(4) The connector 3 according to (3), wherein the partition portion 244 comprises a pair of shell contact portions 243 that are oriented away from each other in the arrangement orientation D2, and each of the pair of shell contact portions 243 is configured to contact an inner surface of the counterpart shell.

By improving the shielding property between the counterpart shell and the partition portion 244, the shielding performance can be further improved.

(5) The connector 3 according to (3) or (4), wherein each of the first shell 220A and the second shell 220B comprises the partition portion 244, and wherein the first accommodation space S11 and the second accommodation space S12 are doubly partitioned by the partition portion 244 of the first shell 220A and the partition portion 244 of the second shell 220B.

The shielding performance between the first accommodation space S11 and the second accommodation space S12 can be further improved.

(6) The connector 3 according to (5), wherein the first shell 220A comprises an opening oriented away from the second shell 220B and the second shell 220B comprises an opening oriented away from the first shell 220A such that the pair of first contacts 210A and the pair of second contacts 210B are in a positional relationship opposite to each other, wherein each of the pair of first contacts 210A comprises a first contact portion 211A that contacts a respective one of the one pair of counterpart first contacts 120 in a direction in which the first shell 220A opens, and wherein each of the pair of second contacts 210B comprises a second contact portion 211B that contacts a respective one of the one pair of counterpart second contacts 130 in a direction in which the second shell 220B opens.

Even without providing a space between the plurality of pairs of first contacts 210A and the plurality of pairs of second contacts 210B, the plurality of pairs of first contacts 210A can be brought into contact with the plurality of pairs of counterpart first contacts 120, and the plurality of pairs of second contacts 210B can be brought into contact with the plurality of pairs of counterpart second contacts 130, respectively. Therefore, both downsizing of the connector 3 and shielding performance can be achieved.

(7) The connector 3 according to any one of (1) to (6), further comprising: an insulative first housing 260A that holds the plurality of pairs of first contacts 210A and the plurality of first shells 220A; and an insulative second housing 260B that is formed separately from the first housing 260A and holds the plurality of pairs of second contacts 210B and the plurality of second shells 220B.

A configuration in which the plurality of pairs of first contacts 210A in the first row are surrounded pair by pair by the plurality of first shells 220A, and the plurality of pairs of second contacts 210B in the second row are also surrounded pair by pair by the plurality of second shells 220B, can be readily assembled by dividing it into two units.

(8) The connector 3 according to (7), wherein the first housing 260A comprises a first mating portion 265 that faces the second housing 260B, and wherein the second housing 260B comprises a second mating portion 275 that mates with the first mating portion 265 so as to prevent relative displacement between the first housing 260A and the second housing 260B along the mating orientation D1 and the arrangement orientation D2.

Both ease of assembly and post-assembly quality can be achieved.

(9) The connector 3 according to (8), wherein the first housing 260A comprises: a first housing base 261 extending along the arrangement orientation D2; and a plurality of first protruding portions 262 protruding from the first housing base 261, wherein the plurality of first protruding portions 262 hold the plurality of pairs of first contacts 210A, one pair of first contacts per first protruding portion, and wherein the plurality of first protruding portions 262 are accommodated in the plurality of first shells 220A, one first protruding portion per first shell 220A, and wherein the second housing 260B comprises: a second housing base 271 extending along the arrangement orientation D2; and a plurality of second protruding portions 272 protruding from the second housing base 271, wherein the plurality of second protruding portions 272 hold the plurality of pairs of second contacts 210B, one pair of second contacts per second protruding portion, and wherein the plurality of second protruding portions 272 are accommodated in the plurality of second shells 220B, one second protruding portion per second shell 220B.

The plurality of first shells 220A can be readily attached to the first housing 260A, and the plurality of second shells 220B can be readily attached to the second housing 260B.

(10) The connector 3 according to (9), further comprising a conductive cover 300 that surrounds the first housing 260A and the second housing 260B around the mating orientation D1 and integrates the first housing 260A and the second housing 260B.

While further improving the shielding performance, the first housing 260A and the second housing 260B can be readily integrated.

(11) The connector 3 according to (10), wherein the plurality of pairs of first insulated wires 30A are surrounded by a plurality of first outer conductors, one pair of first insulated wires per first outer conductor, and the plurality of pairs of second insulated wires 30B are surrounded by a plurality of second outer conductors, one pair of second insulated wires per second outer conductor, and wherein the cover is connected to the plurality of first outer conductors and the plurality of second outer conductors.

By stabilizing the potential of the cover, the shielding performance can be further improved.

(12) A connector system 1 comprising: the connector 3 according to (1); and the counterpart connector 2, wherein the counterpart connector 2 comprises: a plurality of pairs of conductive counterpart first contacts 120, wherein the plurality of pairs of first contacts 210A respectively contact the plurality of pairs of counterpart first contacts 120 in a mated state where the connector 3 is mated with the counterpart connector 2; a plurality of pairs of conductive counterpart second contacts 130, wherein the plurality of pairs of second contacts 210B respectively contact the plurality of pairs of counterpart second contacts 130 in the mated state; and a plurality of counterpart shells surrounding the plurality of pairs of counterpart first contacts 120 and the plurality of pairs of counterpart second contacts 130, one pair of counterpart first contacts 120 and one pair of counterpart second contacts 130 per counterpart shell, wherein the plurality of counterpart shells are configured to accommodate the plurality of pairs of first contacts 210A and the plurality of pairs of second contacts 210B, one pair of first contacts 210A and one pair of second contacts 210B per counterpart shell, and wherein a first shell 220A surrounding the pair of first contacts 210A and a second shell 220B surrounding the pair of second contacts 210B are accommodated in the counterpart shell in the mated state and comprise a partition portion 244 that partitions an interior of the counterpart shell into a first accommodation space S11 and a second accommodation space S12, wherein the pair of first contacts 210A and the pair of counterpart first contacts 120 are accommodated in the first accommodation space S11, and wherein the pair of second contacts 210B and the pair of counterpart second contacts 130 are accommodated in the second accommodation space S12.

(13) The connector system 1 according to (12), wherein the partition portion 244 comprises a pair of shell contact portions 243 that are oriented away from each other in the arrangement orientation D2 and contact an inner surface of the counterpart shell.

(14) The connector system 1 according to (12) or (13), wherein each of the first shell 220A and the second shell 220B comprises the partition portion 244, and wherein the first accommodation space S11 and the second accommodation space S12 are doubly partitioned by the partition portion 244 of the first shell 220A and the partition portion 244 of the second shell 220B.

(15) The connector system 1 according to (14), wherein the first shell 220A comprises an opening oriented away from the second shell 220B and the second shell 220B comprises an opening oriented away from the first shell 220A such that the pair of first contacts 210A and the pair of second contacts 210B are in a positional relationship opposite to each other, wherein each of the pair of first contacts 210A comprises a first contact portion 211A that contacts a respective one of the one pair of counterpart first contacts 120 in a direction in which the first shell 220A opens, and wherein each of the pair of second contacts 210B comprises a second contact portion 211B that contacts a respective one of the one pair of counterpart second contacts 130 in a direction in which the second shell 220B opens.

(16) A method of assembling a connector 3 configured to mate with a counterpart connector 2 along a mating orientation D1, the method comprising: connecting a plurality of pairs of first insulated wires 30A respectively to a plurality of pairs of conductive first contacts 210A of a first unit, the first unit comprising the plurality of pairs of conductive first contacts 210A arranged along an arrangement orientation D2 perpendicular to the mating orientation D1 and an insulative first housing 260A that holds the plurality of pairs of first contacts 210A; connecting a plurality of pairs of second insulated wires 30B respectively to a plurality of pairs of conductive second contacts 210B of a second unit, the second unit comprising the plurality of pairs of conductive second contacts 210B arranged along the arrangement orientation D2 and an insulative second housing 260B that holds the plurality of pairs of second contacts 210B; attaching a plurality of conductive first shells 220A to the first unit so as to surround the plurality of pairs of first contacts 210A to which the plurality of pairs of first insulated wires 30A are respectively connected, one pair of first contacts per first shell 220A; attaching a plurality of conductive second shells 220B to the second unit so as to surround the plurality of pairs of second contacts 210B to which the plurality of pairs of second insulated wires 30B are respectively connected, one pair of second contacts per second shell 220B; and integrating the second housing 260B and the first housing 260A such that the plurality of pairs of first contacts 210A and the plurality of pairs of second contacts 210B are arranged parallel to each other in an orthogonal orientation D3 perpendicular to the mating orientation D1 and the arrangement orientation D2.

It is to be understood that not all aspects, advantages and features described herein may necessarily be achieved by, or included in, any one particular example. Indeed, having described and illustrated various examples herein, it should be apparent that other examples may be modified in arrangement and detail.

What is claimed is:

1. A connector configured to be connected to a plurality of pairs of first insulated wires and a plurality of pairs of second insulated wires and to mate with a counterpart connector along a mating orientation, the connector comprising:
a plurality of pairs of conductive first contacts arranged along an arrangement orientation perpendicular to the mating orientation and configured to be respectively connected to the plurality of pairs of first insulated wires;
a plurality of pairs of conductive second contacts arranged parallel to the plurality of pairs of first contacts in an orthogonal orientation perpendicular to the mating orientation and the arrangement orientation, and configured to be respectively connected to the plurality of pairs of second insulated wires;
a plurality of conductive first shells surrounding the plurality of pairs of first contacts pair by pair around the mating orientation; and
a plurality of conductive second shells surrounding the plurality of pairs of second contacts pair by pair around the mating orientation.

2. The connector according to claim 1, wherein each of the plurality of first shells comprises an opening oriented away from the plurality of pairs of second contacts, and
wherein each of the plurality of second shells comprises an opening oriented away from the plurality of pairs of first contacts.

3. The connector according to claim 1, wherein the counterpart connector comprises:
a plurality of pairs of conductive counterpart first contacts, wherein the plurality of pairs of first contacts respectively contact the plurality of pairs of counterpart first contacts in a mated state where the connector is mated with the counterpart connector;
a plurality of pairs of conductive counterpart second contacts, wherein the plurality of pairs of second contacts respectively contact the plurality of pairs of counterpart second contacts in the mated state; and
a plurality of counterpart shells surrounding the plurality of pairs of counterpart first contacts and the plurality of pairs of counterpart second contacts, wherein each of the plurality of counterpart shells surrounds one pair of counterpart first contacts and one pair of counterpart second contacts,
wherein the plurality of counterpart shells are configured to accommodate the plurality of pairs of first contacts and the plurality of pairs of second contacts in the mated state, wherein each of the plurality of counterpart shells accommodates one pair of first contacts and one pair of second contacts, and
wherein a first shell surrounding the pair of first contacts and a second shell surrounding the pair of second contacts are accommodated in the counterpart shell in the mated state and comprise a partition portion that partitions an interior of the counterpart shell into a first accommodation space and a second accommodation space, wherein the pair of first contacts and the pair of counterpart first contacts are accommodated in the first accommodation space, and the pair of second contacts and the pair of counterpart second contacts are accommodated in the second accommodation space.

4. The connector according to claim 3, wherein the partition portion comprises a pair of shell contact portions that are oriented away from each other in the arrangement orientation, and each of the shell contact portions is configured to contact an inner surface of the counterpart shell in the mated state.

5. The connector according to claim 3, wherein each of the first shell and the second shell comprises the partition portion, and
wherein the first accommodation space and the second accommodation space are doubly partitioned by the partition portion of the first shell and the partition portion of the second shell.

6. The connector according to claim 5, wherein the first shell comprises an opening oriented away from the second shell and the second shell comprises an opening oriented away from the first shell,
wherein each of the pair of first contacts comprises a first contact portion that contacts a respective one of the one pair of counterpart first contacts in a direction away from the second shell, and
wherein each of the pair of second contacts comprises a second contact portion that contacts a respective one of the one pair of counterpart second contacts in a direction away from the first shell.

7. The connector according to claim 6, wherein each of the plurality of first shells comprise a first base portion that accommodates a respective pair of first insulated wires outside the counterpart shell in the mated state, and
wherein each of the plurality of second shells comprise a second base portion that accommodates a respective pair of second insulated wires outside the counterpart shell in the mated state.

8. The connector according to claim 7, further comprising a conductive first base plate extending along the arrangement orientation; and
a conductive second base plate extending along the arrangement orientation and facing the first base plate in the orthogonal orientation,
wherein the first base portion of each of the plurality of first shells and the second base portion of each of the plurality of second shells are located between the first base plate and the second base plate,
wherein the respective pair of first insulated wires are surrounded by the first base portion and the first base plate, and
wherein the respective pair of second insulated wires are surrounded by the second base portion and the second base plate.

9. The connector according to claim 3, wherein the partition portion of the first shell comprises:
a pair of first side wall portions that face with each other in the arrangement orientation; and
a first interconnecting wall portion that interconnects the pair of first side wall portions so that the first shell comprises an opening oriented away from the second shell,
wherein the partition portion of the second shell comprises:
a pair of second side wall portions that face with each other in the arrangement orientation; and
a second interconnecting wall portion that interconnects the pair of second side wall portions so that the second shell comprises an opening oriented away from the first shell.

10. The connector according to claim 9, wherein the pair of first side wall portions respectively comprise a pair of first shell contact portions that are oriented away from each other in the arrangement orientation, and each of the pair of first shell contact portions is configured to contact an inner surface of the counterpart shell in the mated state, and
wherein the pair of second side wall portions respectively comprise a pair of second shell contact portions that are oriented away from each other in the arrangement orientation, and each of the pair of second shell contact portions is configured to contact the inner surface of the counterpart shell in the mated state.

11. The connector according to claim 1, further comprising:
an insulative first housing that holds the plurality of pairs of first contacts and the plurality of first shells; and
an insulative second housing that is formed separately from the first housing and holds the plurality of pairs of second contacts and the plurality of second shells.

12. The connector according to claim 11, wherein the first housing comprises a first mating portion that faces the second housing, and
wherein the second housing comprises a second mating portion that mates with the first mating portion so as to prevent relative displacement between the first housing and the second housing along the mating orientation and the arrangement orientation.

13. The connector according to claim 12, wherein the first housing comprises:
a first housing base extending along the arrangement orientation; and
a plurality of first protruding portions protruding from the first housing base, wherein the plurality of first protruding portions hold the plurality of pairs of first contacts, wherein each of the first protruding portions holds one pair of first contacts, and wherein the plurality of first protruding portions are accommodated in the plurality of first shells, wherein each of the first shells accommodates one first protruding portion, and
wherein the second housing comprises:
a second housing base extending along the arrangement orientation; and
a plurality of second protruding portions protruding from the second housing base, wherein the plurality of second protruding portions hold the plurality of pairs of second contacts, wherein each of the second protruding portions holds one pair of second contacts, and wherein the plurality of second protruding portions are accommodated in the plurality of second shells, wherein each of the plurality of second shells accommodates one second protruding portion.

14. The connector according to claim 13, further comprising a conductive cover that surrounds the first housing and the second housing around the mating orientation and integrates the first housing and the second housing.

15. The connector according to claim 14, wherein the plurality of pairs of first insulated wires are surrounded by a plurality of first outer conductors, wherein each of the plurality of first outer conductors surrounds one pair of first insulated wires, and the plurality of pairs of second insulated wires are surrounded by a plurality of second outer conductors, wherein each of the plurality of second outer conductors surrounds one pair of second insulated wires, and
wherein the cover is connected to the plurality of first outer conductors and the plurality of second outer conductors.

16. A connector system comprising:
the connector according to claim 1; and
the counterpart connector,
wherein the counterpart connector comprises:
a plurality of pairs of conductive counterpart first contacts, wherein the plurality of pairs of first contacts respectively contact the plurality of pairs of counterpart first contacts in a mated state where the connector is mated with the counterpart connector;
a plurality of pairs of conductive counterpart second contacts, wherein the plurality of pairs of second contacts respectively contact the plurality of pairs of counterpart second contacts in the mated state; and
a plurality of counterpart shells surrounding the plurality of pairs of counterpart first contacts and the plurality of pairs of counterpart second contacts, wherein each of the plurality of counterpart shells surrounds one pair of counterpart first contacts and one pair of counterpart second contacts,
wherein the plurality of counterpart shells are configured to accommodate the plurality of pairs of first contacts and the plurality of pairs of second contacts, wherein each of the plurality of counterpart shells accommodates one pair of first contacts and one pair of second contacts, and
wherein a first shell surrounding the pair of first contacts and a second shell surrounding the pair of second contacts are accommodated in the counterpart shell in the mated state and comprise a partition portion that partitions an interior of the counterpart shell into a first accommodation space and a second accommodation space, wherein the pair of first contacts and the pair of counterpart first contacts are accommodated in the first accommodation space, and wherein the pair of second contacts and the pair of counterpart second contacts are accommodated in the second accommodation space.

17. The connector system according to claim 16, wherein the partition portion comprises a pair of shell contact portions that are oriented away from each other in the arrangement orientation and contact an inner surface of the counterpart shell.

18. The connector system according to claim 16, wherein each of the first shell and the second shell comprises the partition portion, and
wherein the first accommodation space and the second accommodation space are doubly partitioned by the partition portion of the first shell and the partition portion of the second shell.

19. The connector system according to claim 18, wherein the first shell comprises an opening oriented away from the second shell and the second shell comprises an opening oriented away from the first shell such that the pair of first contacts and the pair of second contacts are in a positional relationship opposite to each other,
wherein each of the pair of first contacts comprises a first contact portion that contacts a respective one of the one pair of counterpart first contacts in a direction away from the second shell, and
wherein each of the pair of second contacts comprises a second contact portion that contacts a respective one of the one pair of counterpart second contacts in a direction away from the first shell.

20. A method of assembling a connector configured to mate with a counterpart connector along a mating orientation, the method comprising:
connecting a plurality of pairs of first insulated wires respectively to a plurality of pairs of conductive first contacts of a first unit, the first unit comprising the plurality of pairs of conductive first contacts arranged along an arrangement orientation perpendicular to the mating orientation and an insulative first housing that holds the plurality of pairs of first contacts;
connecting a plurality of pairs of second insulated wires respectively to a plurality of pairs of conductive second contacts of a second unit, the second unit comprising the plurality of pairs of conductive second contacts arranged along the arrangement orientation and an insulative second housing that holds the plurality of pairs of second contacts;
attaching a plurality of conductive first shells to the first unit so as to surround the plurality of pairs of first contacts to which the plurality of pairs of first insulated wires are respectively connected, wherein each of the plurality of first shells surrounds one pair of first contacts per first shell;
attaching a plurality of conductive second shells to the second unit so as to surround the plurality of pairs of second contacts to which the plurality of pairs of second insulated wires are respectively connected, wherein each of the plurality of second shells surrounds one pair of second contacts; and
integrating the second housing and the first housing such that the plurality of pairs of first contacts and the plurality of pairs of second contacts are arranged parallel to each other in an orthogonal orientation perpendicular to the mating orientation and the arrangement orientation.
